(19) United States
(12) Patent Application Publication
(10) Pub. No.: US 2024/0059602 A1
(43) Pub. Date: Feb. 22, 2024

(54) INTERLEAVANT PARTICLE COMPOSITIONS FOR LOCATION BETWEEN STACKED GLASS SHEETS

(71) Applicant: MITSUBISHI CHEMICAL UK LIMITED, Billingham, Durham (GB)

(72) Inventors: Philip Andrew STENSON, Newton Aycliffe, Durham (GB); Michael Stephen CHISHOLM, Newton Aycliffe, Durham (GB)

(21) Appl. No.: 18/270,981

(22) PCT Filed: Dec. 22, 2021
(86) PCT No.: PCT/GB2021/053402

§ 371 Date: Jul. 5, 2023

(30) Foreign Application Priority Data
Jan. 7, 2021 (GB) 2100201.9

(51) Int. Cl. C03B 40/033; C03C 17/00

(52) U.S. Cl. CPC C03B 40/033; C03C 17/009; C03C 2218/355; C03C 2217/70

(57) ABSTRACT

A glass interleavant particle composition for location between adjacent stacked glass sheets. The composition includes a) inorganic interleavant particles and b) polymeric adhesion promoter particles in which the inorganic particles are solid up to at least 100° C. have a compressive strength of at least 3 MPa and have a volumetric mass density less than 7.5 g/cm3 at 25° C.

### TECHNICAL FIELD

The present invention relates to glass interleavant particle compositions for location between adjacent stacked glass sheets especially during manufacture, storage and transport.

### BACKGROUND

Glass interleavants provide spacing between stacked glass sheets and thereby help to prevent abrasive contact, capillary adhesion and corrosion by alkalis between adjacent glass sheets.

Commonly used glass interleavants generally comprise non-biodegradable microplastics, such as LDPE (Low Density Polyethylene) and PMMA (Poly(methyl methacrylate)). In particular, the use of PMMA has a number of benefits over other types of glass interleavants, such as affordability, adhesion of interleavant powder to glass, and ease of removal with water.

A key characteristic of PMMA interleavants is the acceptance of electrostatic charge which provides the advantageous adhesion. In addition, PMMA may be produced by suspension polymerisation where the final polymer particle is already of the suitable size for direct use as a glass interleavant—approximately 50-150 μm.

However, non-biodegradable microplastics are known to accumulate in the environment and may harm aquatic organisms and animals.

In January 2019, the European Commission proposed wide-ranging restrictions on the international use of microplastics in products placed on the EU/EEA market to avoid or reduce their release into the environment. The proposal aims at reducing the amount of microplastics emitted into the environment by at least 70% and thereby prevent the release of 500,000 tonnes of microplastics over the twenty-year period following its introduction.

Natural biodegradable materials such as paper, wood flour, natural fabrics, coconut husk flour, and starch have also been used as glass interleavants. These natural materials do not match the performance associated with non-biodegradable glass interleavants. In particular, these natural materials are less effective, particularly when wet, which may be problematic in humid or wet environments. Further disadvantages of natural biodegradable glass interleavants may include staining of the glass sheets, abrasive activity on the glass sheets, compressibility, hydrophilicity (which may lead to capillary uptake of water and subsequent undesirable sticking together of glass sheets) and an inability of interleavant powder to remain adhered to the glass sheets.

Biodegradable polymers such as poly(lactic acid) (PLA) and poly(butylene succinate)(PBS) are generally produced by polycondensation reaction in a solvent system or via fermentation. The product polymer mass after solvent removal is usually extruded in the form of pellets. Glass interleavants generally have a particle size in the range 50-150 μm. Milling such pellets to obtain a suitable particle size leads to poor particle size distribution and high angularity in the particles making them unsuitable as interleavants.

Accordingly, there is a need to provide alternative glass interleavants that are: biodegradable or partially biodegradable, environmentally sustainable, match or substantially match the performance and ease of production of current non-biodegradable glass interleavants such as PMMA and/or release little or no microplastics into the environment.

Glass interleavant compositions also need to sufficiently adhere to the glass so that they remain in situ to act as interleavants whilst at the same time being easily removable when the glass sheets are to be used and without leaving any stain on the glass. Inorganic interleavant particles have not been considered as interleavant particles due to their low adherence on the glass sheets. Surprisingly, it has now been found that use of inorganic interleavant particles with a polymeric adhesion promoter particle is able to increase the adherence of the inorganic interleavant particles.

### SUMMARY OF INVENTION

According to the present invention there is provided a glass interleavant particle composition for location between adjacent stacked glass sheets, the composition comprising:—
a) inorganic interleavant particles and
b) polymeric adhesion promoter particles,
   wherein the inorganic particles are solid up to at least 100° C., have a compressive strength of at least 3 MPa and have a volumetric mass density less than 7.5 g/cm³ at 25° C.

### DETAILED DESCRIPTION OF THE INVENTION

Polymeric adhesion promoters are not known as an effective glass interleavant and are generally not used as such. However, surprisingly, the inventors have found that the addition of certain polymeric particles to inorganic interleavant particles improves adhesion of the inorganic particles to the interleaved glass sheets thus preventing loss of material. It has also been found that the addition of the polymeric particles may reduce the staining of the glass sheets by the interleavant.

Furthermore, the inorganic particles provide structural rigidity to the interleavant composition so that the interleavant composition has sufficient compressive strength to withstand the load applied by the glass sheets when stacked.

Having the inorganic particles solid up to at least up to at least 100° C. allows the particles to maintain their structural rigidity in use, and accordingly they do not deform or melt onto the glass, when exposed to high glass surface temperatures. For example, when exposed to high glass surface temperatures associated with the manufacture of the glass sheets, in particular following cutting of the glass sheets in the final stage of manufacture such as the float glass method.

According to a first aspect of the present invention there is provided a glass interleavant particle composition for location between adjacent stacked glass sheets, the composition comprising:—
a) inorganic interleavant particles and
b) polymeric adhesion promoter particles
   wherein the inorganic particles are solid up to at least 100° C., have a compressive strength of at least 3 MPa and have a volumetric mass density less than 7.5 g/cm³ at 25° C.

According to a second aspect of the invention there is provided a method of providing a stack of spaced glass sheets as claimed.

According to a third aspect of the invention there is provided the use of interleavant particle compositions as claimed.

According to a fourth aspect of the invention there is provided a stack of glass sheets as claimed.

Typically, the particles of a) are microspheres i.e. having an average particle size as determined by light scattering of 1 to 1000 μm. The particles of b) may also be microspheres or may be smaller i.e. the average particle size as determined by light scattering may fall within the range 0.1 to 1000 μm.

Typically, the average particle size of the polymeric adhesion promoter particles of component b) (as determined by light scattering) is 0.1 to 250 μm, typically, 0.5 to 300 μm, more typically, 1 to 250 μm, especially, 1 to 50 μm such as 1 to 30 μm. Typically, the average particle size of the polymeric adhesion promoter particles of component b) (as determined by light scattering) is <250 μm, more typically <100 μm, most typically <40 μm, especially <20 μm.

Optionally, the polymeric adhesion promoter particles may be biodegradable.

Typically, the polymeric adhesion promoter particles are biodegradable.

Typically, the polymeric adhesion promoter particles have a density <5 g/cm³, more typically, <4 g/cm³, most typically, <3 g/cm³.

Typically, the polymeric adhesion promoter particles have a density in the range 0.5-2.5 g/cm³, more typically, 0.5-2.0 g/cm³, most typically, 0.5-1.5 g/cm³.

Typically, the adhesion promoters have a triboelectric charge density (TECD)≤0 μCm⁻²; more typically, ≤−10 μCm⁻², most typically ≤−20 μCm⁻², such as ≤−30 μCm⁻², ≤−40 μCm⁻², <−50 μCm⁻², <−60 μCm⁻², <−70 μCm⁻², <−80 μCm⁻², <−90 μCm⁻² or <−100 μCm⁻².

Accordingly, the adhesion promoters may have a TECD in the range 0 to −180 μCm⁻², typically, −10 to −170 μCm⁻², more typically, −20 to −160 μCm⁻², most typically, −30, −40, −50, −60, −70, −80 or −90 to −150 μCm⁻².

Typically, the polymeric adhesion promoter particles are present in the range 0.1 to 10% w/w total composition, more typically 0.1 to 8% w/w total composition and most typically, 0.1 to 5% w/w total composition.

Typically, the particles of component b) are at a level of up to 20% w/w total composition such as up to 10% w/w total composition, or 5% w/w total composition.

The polymeric adhesion promoter particles are typically, biodegradable. The polymeric adhesion promoter may be selected from:—
a polyester such as a poly(lactic acid), a poly(butylene succinate), a poly(caprolactone) or a poly(hydroxyalkanoate) for example polyhydroxybutyrate,
a polyamide such as a poly(amino acid) or a poly(caprolactam),
a poly(glycolic acid) and
natural or synthetic biopolymers such as biodegradable polyesters, polynucleotides, polypeptides and polysaccharides or derivatives thereof, for example cellulose, lignocellulose, starch, suberin, melanin, lignin, cutin, cutan, chitin, keratin and chitosan.

Examples of synthetic biopolymers include rayon and viscose derived biopolymers.

Preferred polymeric adhesion promoters are natural or synthetic biopolymers.

Preferred natural or synthetic biopolymers are polysaccharides such as cellulose or biodegradable polyesters, more preferably, cellulose, most preferably, microcrystalline cellulose.

The particles of component b) are typically, selected from a polyester or a cellulose, more typically, porous cellulose, microcrystalline cellulose or polyhydroxybutyrate.

Accordingly, the cellulose may be a porous cellulose or a microcrystalline cellulose such as microcrystalline cellulose 20 μm powder purchased from Sigma Aldrich.

A suitable biodegradable polyester may be a polyhydroxybutyrate such as Naturmatte™ PHB.

Optionally, the inorganic interleavant particles of the first aspect further comprise:—
c) an outer coating on the inorganic interleavant particles.

Generally, the outer coating is in the form of a film, typically, of a polymer or film forming material.

Typically, the outer coating is biodegradable and/or water soluble.

In some embodiments, the outer coating is formed of a polymer or a rosin.

Typically, the outer coating is selected from:—
a polyester such as a poly(lactic acid), a poly(butylene succinate), a poly(caprolactone) or a poly(hydroxyalkanoate) for example polyhydroxybutyrate,
a polyether such as a poly(ethylene glycol) or a poly(propylene glycol),
a poly (alk)acrylic acid such as a poly(acrylic acid) or a poly(methacrylic acid),
a polyamide such as a poly(amino acid) or a poly(caprolactam),
a poly(ester-amide) such as a co-polymer of a poly(ester) and an amino acid or a co-polymer of a poly(ester) and an amino acid and an imide,
a polyurethane such as a polyurethane formed from a poly(ester) polyol and an aliphatic diisocyanate,
a poly(vinyl alcohol),
a poly(vinyl acetate),
a poly(acrylate) such as a hydroxyl functional poly(acrylate) such as poly(hydroxyethylacrylate),
a poly(methacrylate) such as a hydroxyl functional poly(methacrylate) such as poly(hydroxyethylmethacrylate),
a poly(glycolic acid),
a poly(peptide) or poly(peptide) derivative such as lacto(peptides), casein, collagen, actin, and fibrin,
a poly(propylene fumarate),
a poly(phosphazene) such as poly[bis(trifluoroethoxyphosphazene],
a poly(phosphoester),
a poly(saccharide) or poly(saccharide) derivative such as chitin, keratin and chitosan, poly(ethylene glycol),
a cellulose such as microfibrillated cellulose, rayon, cellophane, lignocellulose, natural biopolymers and derivatives such as suberin, melanin, lignin, cutin, cutan, starch and starch derivatives, and
a rosin such as gum rosin and derivatives such as a hydrogenated rosin or a metal rosinate.

The polyether may be a poly(ethylene glycol) such as Pluriol® E6000. The poly(alk)acrylic acid may be a polyacrylic acid such as Acusol™ 190K or Acumer™ 1510.

The term rosin herein includes gum rosin, wood rosin, oleorosin, abietic acids, sapinic acids, pimaric acids and the like and any other products that are generally termed colophony. The rosin may be a rosin derivative such as a suitable metal saft (for example zinc or copper), or a polymerized, hydrogenated, disproportionated, esterified or optionally substituted rosin derivative. The rosin derivative may be a partially or fully hydrogenated rosin (such as Staybelite-E™ or Foral AX-E™) or a dimeric rosin acid (such as Dymerex™ dimerised gum rosin). Such materials may be used as film forming material for the outer coating.

Advantageously, when used as the outer coating film forming material the rosin helps to promote adhesion of the glass interleavant particles to the glass sheets.

More typically, the outer coating is selected from polylactic acid, poly butylenesuccinate, polyhydroxybutyrate, polyacrylic acid, a rosin or a cellulose, most typically, the outer coating is a rosin or a cellulose, especially, rosin.

It will be appreciated that component b) and component c), when present and selected from the same material such as cellulose, may be the same type of material but will not be in the same form, the former being in particulate form and thereby at least to some extent independent of component a) and the latter being formed onto the surface of the inorganic interleavant particle a) as an outer coating. Generally, however, if the outer coating is cellulose it is a different type of material to the material of component b). The material particles of component b) are in particulate form and thereby at least to some extent independent of component a).

For the avoidance of doubt, the outer coating when present on component a) is independent of component b).

The Inorganic Interleavant Particles

The inorganic interleavant particles may have a density >2.0 g/cm³, more typically, >2.2 g/cm³, most typically, 2.4>g/cm³. Suitable density ranges for the inorganic interleavant particles are in the range 2.0 to 7.0 g/cm³, more typically, 2.1 to 5.0 g/cm³, most typically 2.2 to 3.0 g/cm³.

The inorganic interleavant particles may have an average particle size as determined by light scattering of ≤400 μm.

The Inorganic interleavant particles may have an average particle size as determined by light scattering of ≥10 μm.

The inorganic interleavant particles may have an average particle size as determined by light scattering of from 20-300 μm.

The inorganic interleavant particles may have an average particle size as determined by light scattering of from 25-200 μm, typically, 50-150 μm.

In terms of particle size distribution, the inorganic interleavant particles may have <10% v/v total particles >400 μm, typically. <1% v/v total particles >500 μm as determined by light scattering. The inorganic interleavant particles may have <10% v/v total particles <1 μm as determined by light scattering.

The average particle size as determined by light scattering, as described previously, may provide uniform spacing between sheets of glass. This in-turn optimizes the amount of interleavant particles used and thereby reduces wastage.

Providing inorganic interleavant particles with an average particle size as determined by light scattering may facilitate application of the interleavant particles to the surface of the glass.

The Inorganic interleavant particles may be generally spherical or cylindrical in shape. Typically, the inorganic interleavant particles are generally spherical in shape. The inorganic interleavant particles may have a smooth or textured surface.

The inorganic interleavant particles herein may be broadly spherical. In any case, the particles will generally have an average aspect ratio of at least 0.5, such as at least 0.6, 0.7, 0.8, 0.9 or 0.95.

The inorganic particle material is chosen to be capable of forming or being formed into generally spherical particles of the required size.

Glass and other inorganic glassy materials are particularly advantageous for this purpose being available in the form of microspheres or being subjectable to milling to form such microspheres.

The inorganic particle has a compressive strength of at least 3 MPa such as at least 5 MPa, typically, at least 10, 50 or 70 MPa.

Compressive strength of the inorganic particle may be taken by measuring the bulk material. Although designed for plastics a suitable technique may be based on the general principles of ASTM D695 (Standard Test Method for Compressive Properties of Rigid Plastics). The general approach for determining compressive strength is to apply a compressive load to a specimen of the material (in the form of cylinder) positioned between two compressive plates mounted in a universal testing machine. The specimen is placed between the compressive plates parallel to the surface and the specimen is then compressed at a uniform rate. The maximum load applied during the test is recorded and the compressive strength is calculated to be the maximum compressive load divided by the cross-sectional area of the specimen. The test should be carried out at 23° C. and a relative humidity of 50%.

The inorganic interleavant particle may be selected from one or more of glass, silica gel, ceramic and mineral materials or may be selected from a metal salt or metalloid compound. Suitably, the inorganic particles may be selected from the group consisting of a metal carbonate (such as calcium carbonate), sulphate (such as calcium sulphate or barium sulphate), borate (such as calcium borate or sodium borate), oxide (such as zirconium dioxide, titanium dioxide or an iron oxide), nitride (such as silicon nitride), oxynitride (such as a sinoite or a perovskite), carbide (such as silicon carbide), titanate (such as calcium titanate) and chlorite (such as a phyllosilicate). Suitable metals and metalloids for the aforementioned compounds may be selected from calcium, sodium, titanium, zirconium, barium, iron, aluminium, magnesium, silicon or copper. Typically, the inorganic particles are a carbonate such as a group II carbonate for example calcium carbonate.

Typically, the inorganic particle is selected from one or more of glass, silica gel, or ceramic materials. Even more typically, the inorganic particle is glass.

Accordingly, the inorganic particle is more typically selected from calcium carbonate or glass.

The inorganic material is advantageously hard but exhibits poor adherence to glass. Advantageously, if the inorganic particle is combined with the polymeric adhesion promoter this prevents the inorganic particle from scratching the glass sheets and improves adherence. The inorganic interleavant particle whether coated or not may be present in amount from 50-99.9% based on the total weight of the interleavant particle composition, typically from 60 to 99.8%, even more typically from 70 to 99.5%, even more typically from 75 to 99%. The inorganic interleavant particle may be in an amount of at least 75% based on the total weight of the interleavant particle composition.

The inorganic interleavant particle may be in an amount of ≥50% based on the total weight of the interleavant particle composition, such as ≥55%, ≥70% or ≥75%.

The inorganic interleavant particle may be in an amount of ≤99.9% based on the total weight of the interleavant particle composition, such as ≤99.8%, ≤99.5% or ≤99%.

The inorganic interleavant particle may be solid up to at least 125° C., 150° C. or 175° C. The inorganic interleavant particles can therefore maintain their structural rigidity, and accordingly do not deform or melt onto the glass, when exposed to high glass surface temperatures. For example, when exposed to high glass surface temperatures associated with the manufacture of the glass sheets, in particular following cutting of the glass sheets or during storage in direct sunlight.

The outer coating material when present as a polymer may have a glass transition temperature (Tg) or softening point from 50 to 200° C. measured using well known techniques such as differential scanning calorimeter (DSC), thermomechanical analysis (TMA) or Ring and Ball (ASTM E28), such as from 60 to 150′C. Advantageously, such a coating allows for good flow of the particles under application temperatures.

Inorganic interleavant particles having the above properties maintain their structural rigidity, and accordingly do not deform or melt onto the glass, when exposed to high glass surface temperatures. For example, when exposed to high glass surface temperatures associated with the manufacture of the glass sheets, in particular following cutting of the glass sheets.

Outer Coating

Advantageously, with the present invention it has been found that providing inorganic interleavant particles and an outer coating can solve or mitigate many of the problems associated with synthetic non-biodegradable based glass interleavants and natural biodegradable interleavants. In particular, the outer coating may degrade naturally or dissolve to thereby release little or no microplastics into the environment. The outer coating also does not abrade the glass sheets.

A still further advantage is that by choosing a particle that is itself glass or closely related to glass, the film forming material can both adhere as a coating to the glass and have residual adherence to the glass sheets in use.

The outer coating may also be environmentally sustainable. The term environmentally sustainable used throughout the description is taken to mean the use of natural resources in such a way that does not lead to long term damage of the environment including the biosphere.

The outer coating may be more compressible than the inorganic interleavant particle. The outer coating may be more compressible than the inorganic interleavant particle up to at least a temperature of 100° C. The inorganic interleavant particle may be incompressible or substantially incompressible in use, when located between glass sheets, i.e. when force is applied via the glass sheets, typically a stack of glass sheets.

Advantageously, having an incompressible or substantially incompressible inorganic interleavant particle and a compressible outer coating also allows for an increased number of glass sheets to be stacked in a single stack.

Optionally, the outer coating is hydrophobic. This helps to prevent or mitigate water retention on the surface of the glass sheets when in use, which may lead to staining of the glass during high temperatures or humid conditions. This may also prevent water from migrating to the particle. Alternatively, a hydrophobic layer may be applied to the outer coating.

Typically, the outer coating adheres to the glass sheet surfaces under the influence of intrinsic tackiness and/or electrostatic charge when in use. Generally, where necessary, sufficient electrostatic charge is imparted by the applicators used for interleavants which charge the interleavant particles as they are sprayed on to the glass sheets. This also helps to prevent the interleavant particles rolling or slipping off the glass sheet and becoming denuded in use.

The outer coating may cover at least a part of the surface of the inorganic interleavant particle. Partially covering the surface of the inorganic interleavant particle prevents or helps to mitigate abrasive contact between the particle and the glass sheets. For example, the outer coating helps to prevent the particle from scratching the glass sheets.

Typically, the outer coating is contiguous with the inorganic interleavant particle so as to cover the entire surface of the particle. Typically, the outer coating envelopes the inorganic interleavant particle. Covering the entire surface of the inorganic interleavant particle with the outer coating prevents abrasive contact between the particle and the glass sheets.

Typically, the outer coating is arranged such that the inorganic interleavant particle substantially does not contact the glass sheets in use.

The outer coating effectively cushions the glass sheet form the particle in use. This prevents abrasion of the glass sheet surface by the particle.

However, it is also possible to have less than 100% surface coating coverage of the inorganic interleavant particle and optionally for some of the particle to also contact the glass sheets in use. The inorganic interleavant particle may have a surface coating coverage of >10% such as >20, 30, 40, 50 or 60% by the outer coating, typically >70%, more typically ≥80%, even more typically ≥90%. The inorganic interleavant particle may have a coating coverage of 100% by the outer coating.

The outer coating may be arranged to be in contact with the inorganic interleavant particle, typically, by direct coating of the particle i.e. without an intervening layer.

Although multiple coats of the outer coating may be applied to the inorganic interleavant particle, preferably only one coat of the outer coating is applied to the particle.

Nevertheless, one or more additional coating layers may also be interposed between the outer coating and the inorganic interleavant particle. The one or more additional coating layers may independently cover at least a part of the surface of the inorganic interleavant particle.

The one or more additional coating layers may be otherwise defined as the outer coating herein.

Typically, the outer coating leaves little or no residue on the glass surface, such as polymer residue.

The interleavant particle outer coating may be biodegradable. The one or more additional coating layers may be biodegradable.

The interleavant particles may be environmentally sustainable. The outer coating may be environmentally sustainable. The one or more additional coating layers may be environmentally sustainable.

The outer coating may be in an amount of ≥0.1% based on the total weight of the coated interleavant particles, such as ≥0.2% or ≥0.5%.

The outer coating may be in an amount of ≤40% based on the total weight of the coated interleavant particles, such as ≤20% or ≤10%.

The outer coating may be in an amount from 0.1-40% based on the total weight of the coated interleavant particles, typically from 0.2 to 30%, even more typically from 0.5 to 25%. The outer coating may be in an amount of at least 4, 8 or 20% based on the total weight of the coated interleavant particles.

The outer coating may have an uncompressed thickness of ≤50 μm, typically, <30, more typically, <20 μm.

The outer coating may have an uncompressed thickness of ≥0.1 μm, more typically, >0.2 μm, more typically, >0.5 μm.

The outer coating may have an uncompressed thickness of from 0.1 to 50 μm, more typically, 0.2 to 30 μm, most typically, 0.5 to 20 μm. ≥65% of the inorganic interleavant particles may be coated with the outer coating having such uncompressed thickness. ≥75% of the inorganic interleavant particles may be coated with the outer coating having such uncompressed thickness. ≥85% of the inorganic interleavant particles may be coated with the outer coating having such uncompressed thickness. ≥95% of the inorganic interleavant particles may be coated with the outer coating having such uncompressed thickness and, in each case, this may be any one of the uncompressed thickness limits or ranges above.

The uncompressed thickness may be determined by a subtraction method whereby the average particle size of the uncoated particle is subtracted from the average particle size of the coated particle. Particle size in this context is determined by the light scattering techniques mentioned herein.

When a rosin is utilized as the outer coating, the coating may have an uncompressed thickness of ≤30 μm. Typically, the coating may have an uncompressed thickness of ≥0.1 μm.

Such a coating may have an uncompressed thickness of from 0.2-28 μm, typically, an uncompressed thickness of from 0.5-20 μm.

A water soluble outer coating may have a water solubility at pH 7 and 20° C. of ≥2 g/L.

A water soluble outer coating may have a water solubility at pH 7 and 20° C. of from 2-200 g/L, such as from 2-50 g/L.

The Mohs hardness in the Mohs hardness scale of the outer coating may be from 1 to 7, such as from 1 to 6, for example 1 to 5.

Typically, the outer coating is of a Mohs hardness that does not scratch or abrade the surface of the glass sheets when in use.

The outer coating when polymeric as defined above may comprise one or more further monomer residues.

The outer coating if polymeric may have a weight average molecular weight (Mw) of ≤750,000 Da. The outer coating if polymeric may have a weight average molecular weight (Mw) of ≥2500 Da.

When polymeric, the outer coating may optionally be a block copolymer, an alternating copolymer, or a random copolymer. The outer coating may be a linear polymer or branched polymer.

Molecular weight herein may be determined by GPC using appropriate standards.

The outer coating may comprise two or more polymers to further modify the properties of the outer coating.

The outer coating may be in the form a polymer blend.

The outer coating may be combined with the inorganic interleavant particle by melt processing of the inorganic interleavant particles and outer coating material in an extruder or other melt processing apparatus.

Alternatively, slurry casting techniques can be used whereby the outer coating material is dispersed or dissolved in a solvent, mixed with inorganic interleavant particles to form a slurry and then the solvent is removed by a drying process such as spray drying, oven drying, vacuum drying, filter drying, fluidised bed drying or pan drying to produce the combination of inorganic interleavant particles and outer coating material. Alternatively, an aqueous dispersion of outer coating material may be mixed with the inorganic interleavant particle and the coating may be applied to the inorganic interleavant particle by coagulation or precipitation techniques followed by a suitable drying process. Alternatively, water may be added to a blend of the inorganic interleavant particles and the outer coating material to dissolve or partially dissolve the outer coating and deposit it on the outer surface of the inorganic interleavant particle. The material may then be dried as per one of the drying processes described above.

The outer coating may be applied to the inorganic interleavant particle by any suitable method, for example melt processing or coagulation/precipitation.

Additives

The compositions may further comprise additives or may be mixed with suitable additives such as selected from one or more of an acid functional modifier, or flow modifier. The additives may be biodegradable.

Suitable flow modifiers include alumina and fumed silica for example Aerosil™.

The acid functional modifier advantageously further prevents or mitigates staining of the glass sheets. The acid functional modifier may also modify viscosity of the outer coating.

Generally, the composition may comprise one or more further additives in an amount of ≥1% based on the total weight of the composition, such as ≥5%, ≥10% or ≥15%.

The composition may comprise one or more further additives in an amount of ≤40% based on the total weight of the composition, such as ≤35%, ≤30% or ≤20%.

Although the additive may be added to the outer coat when present, it is more usually mixed with the interleavant particles, for example it may be dry blended with the particles. This may take place before, after or at the same time as any dry blending with the polymeric adhesion promoter particles which may also independently be dry blended therewith.

Typically, the acid functional modifier is selected from one or more of adipic acid, boric acid, maleic acid, succinic acid, malic acid, benzoic acid, sebacic acid, gum rosin (with the proviso that this is not the same material as the outer coating material when present), a gum rosin derivative or a polyacrylic acid, typically, the acid functional modifier is adipic acid, boric acid or maleic acid.

The amount of the acid functional modifier that may be combined with the composition may be combined in proportions ranging from 1 part per 100 parts composition to 3 parts per 1 part composition. The glass sheets of any of these aspects may be flat or curved glass. Suitable glass sheets for the present invention are float glass and borosilicate glass,

Methodology

The inorganic interleavant particles may be prepared by ultrasonic spray pyrolysis.

Alternatively, the inorganic particles may be prepared by milling.

The interleavant compositions may be applied to the glass sheets by any suitable technique. Typically, the interleavant composition is disposed onto the surface of the glass sheet by spreading, typically, by randomly spreading, an amount of about 100-8000 mg/m² of glass sheet, typically about 200-6000 mg/m².

Triboelectric charge density is determined using the by measuring charge transfer between a given polymer material and a liquid mercury reference via a method described in Nature Communications 2019, 10; 1427 including Supplementary information https://www.nature.com/articles/s41467-019-09461-x#Sec9

### Definitions

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, any numerical range recited herein is intended to include all sub-ranges subsumed therein. Singular encompasses plural and vice versa. For example, although reference is made herein to “an” alcohol, “a” compound according to formula (1), “a” rheology modifier, and the like, one or more of each of these and any other components can be used.

As used herein, the term “polymer” refers to oligomers and both homopolymers and copolymers, and the prefix “poly” refers to two or more. Including, for example and like terms means including for example but not limited to. Additionally, although the present invention has been described in terms of “comprising”, the processes, materials, and compositions detailed herein may also be described as “consisting essentially of” or “consisting of”.

By glass herein is meant a silicate, preferably a borosilicate, an aluminosilicate, a soda-lime silicate or a soda-lime-borosilicate. Typically, the glass herein, particularly in relation to the glass sheets is not fused silica or quartz glass.

By silica gel herein is meant a silicate with a porous surface structure.

References to light scattering herein may be taken to mean as determined using a Coulter LS230 laser diffraction instrument unless indicated otherwise.

Biopolymer herein means a biodegradable polymer whether obtained naturally or synthetically.

The term biodegradable herein may be taken as referring to material susceptible to degradation by biological activity. Herein biodegradable may be defined as ≥90% degradation within 24 months relative to a microcrystalline cellulose powder control sample. Degradation is measured as per methodology outlined in ISO 17556:2019 wherein it is quantified as carbon dioxide evolution from a sample of test material in a natural soil environment (using an inoculum that has not been pre-adapted) expressed as % carbon dioxide evolution relative to the theoretical maximum carbon dioxide evolution.

The term density means the volumetric mass density at 25° C. unless indicated otherwise.

The cellulose outer coating may include cellulose derivatives. A suitable cellulose material includes but is not limited to, a cellulose ether, a microfibrillated cellulose, a cellulose ester, an enzymatically treated cellulose or an optionally substituted cellulose. The cellulose ether may be a material such as methyl cellulose, ethyl cellulose, hydroxy ethyl cellulose, hydroxypropyl cellulose, hydroxypropyl methyl cellulose or carboxy methylcellulose. The hydroxy ethyl cellulose may be Natrosol™250 HEC. The microfibrillated cellulose may be Exilva® F01-V or Exilva® F01-L. Such materials may be used for the outer coating.

The biodegradable material may comprise a L(+)-lactic acid monomer residue and a D(−)-lactic acid monomer residue.

Glass sheets referred to herein are known to the skilled person in the art of glass sheet production and transport where interleavants are required. However, for the avoidance of doubt, such sheets would typically cover an area of at least 0.5 m², more typically such sheets are much larger without limit of size and determined only by transport and manufacturing limitations such as up to 30, 50 or 100 m²

Where ranges are provided in relation to a genus, each range may also apply additionally and independently to any one or more of the listed species of that genus. All of the features contained herein may be combined with any of the above aspects in any combination.

For a better understanding of the invention, and to show how embodiments of the same may be carried into effect, reference will now be made, by way of example, to the following experimental data.

### EXAMPLES

### Examples

Characterisation Techniques

The mean particle size of the powder samples is determined using a Coulter LS230 laser diffraction instrument. Density in g/cm³ is determined by pouring a sample of the powder into a measuring cylinder. The side of the cylinder is tapped to loosen the powder and expel any pockets of air. Sample is added to a volume of 20 cm³. The mass of the sample is noted and the density recorded as the ratio of the mass (g) over the volume (cm³).

### Example 1

Calcium Carbonate (≤50 μm mean particle size, purchased from Sigma Aldrich, 95 g) was added to Cellulose (microcrystalline powder, 20 μm, purchased from Sigma Aldrich, 5 g) and blended at room temperature in a 2-blade high shear mixer (350 W, 0.6 L, >1000 RPM) for 5 minutes. The particle size of the resultant mixture was measured by laser diffraction, results are shown in Table 1.

### Example 2

Calcium Carbonate (≤50 μm mean particle size, purchased from Sigma Aldrich, 95 g) was added to Poly(hydroxybutyrate) Naturematte™ powder (5 g) (available from MicroPowders) and blended at room temperature in a 2-blade high shear mixer (350 W, 0.6 L, >1000 RPM) for 5 minutes. The particle size of the resultant mixture was measured by laser diffraction, results are shown in Table 1.

### Example 3

Rosin coated glass microspheres (prepared by method described in Comparative Example 3, 95 g) were added to Cellulose (Viscopeard D-5, 5 g) and the two powders blended together at room temperature in a 0.3 L container by manual agitation for 5 minutes before further blending using a laboratory roller/mixer (60 RPM) for 2 hours until a homogeneous mixture was obtained. The particle size of the resultant mixture was measured by laser diffraction, results are shown in Table 1.

### Example 4

Rosin coated glass microspheres (prepared by method described in Comparative Example 3, 95 g) were added to Cellulose (Viscopeard D-10, 5 g) and the two powders blended together at room temperature in a 0.3 L container by manual agitation for 5 minutes before further blending using a laboratory roller/mixer (60 RPM) for 2 hours until a homogeneous mixture was obtained. The particle size of the resultant mixture was measured by laser diffraction, results are shown in Table 1.

### Example 5

Rosin coated glass spheres (prepared by method described in Comparative Example 3. 95 g) were added to Cellulose (microcrystalline powder, mean particle size 20 μm, purchased from Sigma Aldrich, 5 g) and the two powders blended together at room temperature in a 0.3 L container by manual agitation for 5 minutes before further blending using a laboratory roller/mixer (60 RPM) for 2 hours until a homogeneous mixture was obtained. The particle size of the resultant mixture was measured by laser diffraction, results are shown in Table 1.

### Comparative Example 1

Calcium Carbonate (≤50 μm mean particle size) was purchased from Sigma Aldrich. The particle size was measured by laser diffraction.

### Comparative Example 2

Calcium Carbonate (<50 μm mean particle size, purchased from Sigma Aldrich, 100 g) and blended at room temperature in a 2-blade high shear mixer (350 W, 0.6 L, >1000 RPM) for 5 minutes to reduce the primary particle size. The particle size of the resultant material was measured by laser diffraction, results are shown in Table 1.

### Comparative Example 3

Glass Microspheres (mean particle size 50 μm measured by laser diffraction, 99 g) and powdered hydrogenated rosin (Foral AX-E™, 1 g) were blended together at room temperature in a 0.3 L container by manual agitation for 5 minutes before further blending using a laboratory roller/mixer (60 RPM) for 2 hours until a homogeneous mixture was obtained. The powder was heated to 175° C. for 2 h in an air circulating oven to melt the hydrogenated rosin. The mixture was stirred and returned back to the oven at 175° C. for a further 1 h. Further cycles of oven treatment (175° C.) and agitation were employed to homogenise the sample. The mixture was cooled to room temperature and sieved through a 200 μm mesh to yield the final composite. A thin coating of the glass microspheres with hydrogenated rosin is observed by microscopic inspection of the particles. This is observable as a translucent film that coats the outside of the clear glass microspheres. The particle size was measured by laser diffraction.

### Comparative Example 4

Glass Microspheres mean particle size 50 μm were purchased from LordsWorld. The particle size was measured by laser diffraction.

Samples from Examples 1-5 and Comparative Examples 1-4 were assessed for adhesion to glass by application of powder (200 mg, applied using a powder spray bottle) to lightly coat the surface of a 300×300×4 mm section of float glass. The adhesion to glass was determined by elevating the glass sheet to a 90° angle and firmly tapping the glass panel on the bench top to enable any loosely adhering particles to be released. Non-adhering material was collected and the mass quantified. The % mass retention of powder on the glass surface (i.e. the glass adhesion) was quantified for each sample. Table 1 Indicates the enhanced glass adhesion performance associated with Examples 1-5 compared to Comparative Examples 1-4 for which no adhesion promoter is present. A sample with good adhesion to glass is considered to be when the % retention is ≥70%.

Comparative examples 1 to 4 have % retention values on glass of between 39% to 62% (less than the threshold value of 70%) and are therefore deemed to have low adhesion to glass. On the other hand, examples 1 to 5 have % retention values on glass of between 73 to 96% (greater than the threshold value of 70%) and are therefore deemed to have good adhesion to glass.

| | | Particle | Adhesion |
|---|---|---|---|
| | Density | Size | to Glass |
| Example | (g/cm³) | (μm) | (%) |
| Comparative | 2.7 | 46.9 | 58% |
| Example 1 | | | |
| Comparative | 2.7 | 31.1 | 52% |
| Example 2 | | | |
| Comparative | 2.5 | 52.3 | 62% |
| Example 3 | | | |
| Comparative | 2.5 | 52.0 | 39% |
| Example 4 | | | |
| 1 | 2.65 | 26.8 | 81% |
| 2 | 2.6 | 32.5 | 96% |
| 3 | 2.45 | 44.1 | 86% |
| 4 | 2.45 | 44.3 | 77% |
| 5 | 2.45 | 46.7 | 73% |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A glass interleavant particle composition for location between adjacent stacked glass sheets, the composition comprising:
a) inorganic interleavant particles and
b) polymeric adhesion promoter particles
wherein the inorganic particles are solid up to at least 100° C., have a compressive strength of at least 3 MPa and have a volumetric mass density less than 7.5 g/cm³ at 25° C.

2. The glass interleavant particle composition according to claim 1, wherein the inorganic particles further comprise:—
c) an outer coating on the inorganic particles.

3. The glass interleavant particle composition according to claim 1, wherein the polymeric adhesion promoter is biodegradable.

4. The glass interleavant particle composition according to claim 1, wherein the adhesion promoters have a triboelectric charge density (TECD)≤0 μCm⁻².

5. (canceled)

6. (canceled)

7. The glass interleavant particle composition according to claim 1, wherein an average particle size of the polymeric adhesion promoter particles of component b) (as determined by light scattering) is <250 μm.

8. The glass interleavant particle composition according to claim 1, wherein the polymeric adhesion promoter particles have a density <5 g/cm³.

9. (canceled)

10. The glass interleavant particle composition according to claim 1, wherein the polymeric adhesion promoter particles are present in the range 0.1 to 10% w/w total composition.

11. The glass interleavant particle composition according to claim 1, wherein the polymeric adhesion promoter is selected from:
a polyester such as a poly(lactic acid), a poly(butylene succinate), a poly(caprolactone); a poly(hydroxyalkanoate);
a polyamide;
a poly(glycolic acid); and
natural or synthetic biopolymers.

12. (canceled)

13. The glass interleavant particle composition according to claim 1, wherein the polymeric adhesion promoter is a porous cellulose or a microcrystalline cellulose.

14. (canceled)

15. The glass interleavant particle composition according to claim 1, wherein the polymeric adhesion promoter is polyhydroxybutyrate.

16. The glass interleavant particle composition according to claim 1, wherein the polymeric adhesion promoter of component b) is at a level of up to 20 wt % of the composition.

17. The glass interleavant particle composition according to claim 2, wherein the outer coating is a powder coating.

18. The glass interleavant composition according to claim 2, wherein the outer coating when present on component a) is independent of component b).

19. (canceled)

20. The glass interleavant particle composition according to claim 2, wherein the outer coating is in the form of a film.

21. The glass interleavant particle composition according to claim 2, wherein the outer coating is formed of a polymer or a rosin.

22. The glass interleavant particle composition according to claim 2, wherein the outer coating is selected from:
a polyester, a poly(butylene succinate), a poly(caprolactone) or a poly(hydroxyalkanoate),
a polyether,
a poly (alk)acrylic acid,
a polyamide,
a poly(ester-amide),
a polyurethane,
a poly(vinyl alcohol),
a poly(vinyl acetate),
a poly(acrylate),
a poly(methacrylate),
a poly(glycolic acid),
a poly(peptide) or poly(peptide) derivative,
a poly(propylene fumarate),
a poly(phosphazene),
a poly(phosphoester),
a poly(saccharide) or poly(saccharide) derivative,
a cellulose and derivatives thereof, and
a rosin.

23. (canceled)

24. (canceled)

25. (canceled)

26. The glass interleavant particle composition according to claim 1, wherein the amount of the polymer or film forming material in the outer coating is from 25-100% based on the total weight of the outer coating.

27. The glass interleavant particle composition according to claim 1, wherein the inorganic interleavant particles have a density >2.0 g/cm³.

28. (canceled)

29. The glass interleavant particle composition according to claim 1, wherein the inorganic interleavant particles have a compressive strength of at least 3 MPa.

30. The glass interleavant particle composition according to claim 1, wherein the inorganic interleavant particles have an average particle size as determined by light scattering of ≤400 μm.

31. (canceled)

32. The glass interleavant particle composition according to claim 2, wherein the outer coating has an average uncompressed thickness of 0.1-50 μm.

33. The glass interleavant particle composition according to claim 2, wherein the outer coating when polymeric has a glass transition temperature (Tg) or softening point from 50 to 200° C.

34. The glass interleavant particle composition according to claim 1, wherein the inorganic interleavant particle is a glass, silica gel, or metal salt.

35. (canceled)

36. (canceled)

37. (canceled)

38. (canceled)

39. The glass interleavant particle composition according to claim 1, wherein the inorganic particles of component a) are coated glass or calcium carbonate.

40. The glass interleavant particle composition according to claim 1, wherein the core of a coated interleavant particle is from 50-99.9% w/w coated inorganic interleavant particles.

41. The glass interleavant particle composition according to claim 2, wherein when coated, the amount of the outer coating is from 0.1-40% w-w coated inorganic interleavant particles.

42. The glass interleavant particle composition according to claim 1, wherein the composition includes an additive.

43. The glass interleavant particle composition according to claim 42, wherein the additive is selected from one or more of an acid functional modifier or flow modifier.

44. A method of providing a stack of spaced glass sheets, the method comprising:
(i) providing a composition according to claim 1;
(ii) applying the composition onto a first surface of a glass sheet; and
(iii) laying a further glass sheet over the said first surface of the glass sheet.

45. The method according to claim 44, wherein the stack of spaced glass sheets comprises three or more glass sheets, suitably by repeating the steps of (ii) and (iii) in relation to each succeeding glass sheet.

46. The method according to claim 44, wherein the glass sheets are float glass, annealed glass, toughened glass, soft coated glass, hard coated glass or laminated glass.

47. The method according to any of claim 44, wherein the composition is disposed onto the surface of the glass sheet by spreading an amount of at least 25 mg/m² of glass sheet.

48. The method according to claim 47, wherein the composition is applied to the glass sheets by an applicator which charges the inorganic interleavant particles as they are sprayed on to the glass sheets with sufficient electrostatic charge.

49. The method according to claim 44, wherein the thickness of the glass is from 1 to 30 mm.

50. (canceled)

51. (canceled)

52. (canceled)

53. A stack of glass sheets, wherein the glass sheets are spaced apart by a composition according to claim 1.

54. The stack of glass sheets according to claim 53, wherein the glass sheets are float glass, annealed glass, toughened glass, soft coated glass, hard coated glass or laminated glass.

55. The stack of glass sheets according to claim 53, wherein the thickness of the glass is from 1 to 30 mm.
